(19) United States
(12) Patent Application Publication
(10) Pub. No.: US 2014/0065377 A1
(43) Pub. Date: Mar. 6, 2014

(54) ABRASUIB-RESISTANT, HAND-TEARABLE ADHESIVE TAPE

(71) Applicant: Berry Plastics Corporation, Evansville, IN (US)

(72) Inventors: Richard Edward Horvath, Fountain Run, KY (US); Roland Hasso Horst, Franklin, KY (US)

(21) Appl. No.: 14/016,729

(22) Filed: Sep. 3, 2013

Related U.S. Application Data
(60) Provisional application No. 61/696,688, filed on Sep. 4, 2012.

(51) Int. Cl. C09J 7/04; D03D 1/00; D03D 13/00

(52) U.S. Cl. CPC C09J 7/04; D03D 13/004; D03D 1/00
USPC 428/193; 442/203; 427/207.1

(57) ABSTRACT

An abrasion resistant hand-tearable adhesive tape comprising a non-symmetrical weave fabric to which at least one adhesive has been applied. In exemplary embodiments, at least one sealant is applied to the fabric prior to application of the adhesive. The tape may be manufactured in rolls that can be unwound by hand and tape torn by hand.

### RELATED APPLICATION

This application claims priority under 35 U.S.C. §119(e) to U.S. Provisional Application Ser. No. 61/696,688, filed Sep. 4, 2012, which is expressly incorporated by reference herein.

### BACKGROUND

The present disclosure relates to adhesive tapes. In exemplary embodiments, the present disclosure relates to adhesive tapes incorporating a woven fabric facing that provides high abrasion resistance and are hand tearable.

### SUMMARY

An adhesive tape in accordance with the present disclosure provides a tape having high abrasion resistance and is hand tearable.

In exemplary embodiments, an abrasion resistant hand-tearable adhesive tape is provided comprising a non-symmetrical weave fabric to which at least one adhesive has been applied. In exemplary embodiments, at least one sealant is applied to at least a portion of the fabric prior to application of the adhesive. The tape may be manufactured in rolls that can be unwound by hand and tape torn by hand. An adhesive tape is disclosed comprising a fabric having an adhesive applied thereto.

In exemplary embodiments, the non-symmetrical weave provides two faces with different relative amounts of warp and weft yarns exposed. High abrasion resistance and hand tearability are provided by the selection of the warp and weft yarns and the weave pattern.

In exemplary embodiments, an adhesive tape comprises polyester yarns provided as a satin weave. In exemplary embodiments, a sealant is applied as a layer to one face of the fabric, such as the warp face. An adhesive material is applied to the sealant layer. In exemplary embodiments, the tape can be wound to form a roll or formed into sheets, strips, or other segmented portions. In exemplary embodiments, the roll or segmented portions may optionally include a release liner. In exemplary embodiments, a symmetrical twill weave fabric may be used.

In exemplary embodiments, a hand-tearable adhesive tape is provided comprising a fabric comprising a polyester material woven in a non-symmetrical pattern of comprising at least four weft yarns floating over a warp yarn and having a first face and a second face, the warp yarn having a denier of 40, the weft yarn having a denier of 300 and the fabric having a density ratio greater than 6.0. In exemplary embodiments, a sealant comprising a water-based polyurethane emulsion, an acrylic adhesive may be applied to the fabric. An adhesive is applied to the fabric. The tape thus formed may have abrasion resistance of at least 3000 cycles, as measured according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11. The tape may have tear resistance of less than 370 g as measured by the Elmendorf tear method, ASTM D-1424.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

Exemplary aspects of the present disclosure are illustrated in the drawings in which like reference characters designate the same or similar parts throughout the figures of which:

FIG. 1 is a schematic view of an adhesive tape constructed to be a protective sleeve for a continuous spiral harness wrap, the sleeve incorporating at least one band of the adhesive tape according to one exemplary embodiment;

FIG. 2 is a schematic view of an adhesive tape constructed to be a protective sleeve for a continuous spiral harness wrap, the sleeve incorporating a band of adhesive tape at each end of the tape, according to one exemplary embodiment; and

FIG. 3 is a schematic view of an adhesive tape constructed to be a protective sleeve for a continuous spiral harness wrap, the sleeve incorporating a wider band of adhesive tape at just one end of the tape, according to one exemplary embodiment.

### DETAILED DESCRIPTION

In exemplary embodiments, the present disclosure provides an adhesive tape comprising a non-symmetrically woven fabric backing and an adhesive layer. Optionally, a release liner may be included. The adhesive tape may be manufactured as a roll, sheet, strip, segments, or the like. The backing comprises a fabric woven in a non-symmetrical pattern. For the purposes of the present disclosure, a “non-symmetrical” pattern is a pattern in which one side or face of the fabric will have more warp yarns or threads showing and the other side or face will have more weft (also known as “fill”) yarns showing. This is in contrast to “plain weave” fabrics that have weave patterns that produce symmetrical faces.

In exemplary embodiments, the fabric may be made of a material capable of being made into a fabric with high abrasion resistance and that is hand tearable. In exemplary embodiments, the fabric may be made of one or more materials set forth in Table 1.

TABLE 1

| | | Trade |
|---|---|---|
| Synthetic Fibers | Chemical Name | Name(s) |
| Polyester, PET | poly(ethylene terephthalate), homo- and co-polymers | |
| Polyester, PBT | poly(butylene terephthalate), homo- and c0-polymers | |
| Polyester, PEN | poly(ethylene naphthalate) homo- and co-polymers | |
| Polyaramide | poly(isopthaloylchloride/m-phenylenediamine) | Nomex ™ |
| Polyaramide | poly(isopthaloylchloride/p-phenylenediamine) | Nomex ™, |
| | | Technor ™ |
| Polyamid | poly[imino(1,6-dioxo-1,6-hexanediyl)imino-1,6-hexanediyl] | Nylon 6,6 |
| Polyamid | poly(hexamethylene dodecanediamide) | Nylon 6/12 |
| PPT, PPTA | poly(paraphenylene terephthalamide) | Kevlar ™, |
| | | Twaron ™ |
| PBO, poly-benzoxazole | poly[(benzo-[1,2-d:5,4-d_]-benzoxazole-2,6-diyl)-1,4-phenylene] | Zylon ™ |
| PBT, poly-benzothiazole | poly[(benzo-[1,2-d:4,5-d_]-benzothiazole-2,6-diyl)-1,4-phenylene] | |
| PBI | polybenzimidazole | |
| PIPD | poly{2,6-diimidazo[4,5-b:4′5′-e]pyridinylene-1,4(2,5-dihydroxy) | M5 |
| | phenylene} | |
| PAN, carbon fiber | Polyacrylonitrile (PAN)-based carbon | |
| PEEK | Polyetheretherketone | |
| Acrylic | Poly(acrylonitrile), poly(acrylate) or copolymers | |
| Aromatic Liquid Crystal | Polycondensation of 4-hydroxybenzoic acid and 6- | Vectran ™ |
| | hydroxynaphthalene-2-carboxylic acid | |
| Polyurethane | Aliphatic or aromatic polyester or polyether polyurethanes | |

In exemplary embodiments, the fabric may be made of plant fibers, such as, but not limited to, cotton, flax, hemp, coconut, sisal, hemp, jute, kenaf, rattan, bamboo, abaca, and mixtures, blends and combinations of the foregoing, and the like. In exemplary embodiments, the fabric may be made of animal fibers, such as, but not limited to, wool, mohair, silk, and mixtures, blends and combinations of the foregoing, and the like.

In exemplary embodiments, the fabric may be made of a polyester material.

In exemplary embodiments, the fabric may be formed as a satin weave. A satin weave is characterized by, for example, four or more weft or weft years floating over a warp yarn, or vice versa, four warp yarns floating over a single weft yarn.

In exemplary embodiments of a satin weave, the warp yarns may have a denier of less than about 100 denier. In exemplary embodiments of a satin weave, the warp yarns may have a denier in a range of 20-100 denier. In exemplary embodiments of a satin weave, the warp yarns may have a denier in a range of 30-70 denier. In exemplary embodiments of a satin weave, the weft yarns may have a denier of at least about 100 denier. In exemplary embodiments of a satin weave, the weft yarns may have a denier in a range of 100-1000 denier. In exemplary embodiments of a satin weave, the weft yarns may have a denier in a range of 150-600 denier.

In exemplary embodiments, the fabric is formed as a twill weave. A twill weave has a pattern of diagonal parallel ribs in which the pattern of weft in one row is offset from the weft pattern in the adjacent rows. The step or offset between the rows creates the diagonal pattern. In exemplary embodiments, a broken twill pattern can be employed. A broken twill pattern diminishes the distinct appearance of the diagonal lines. In other exemplary embodiments, a symmetrical twill weave may be used.

The specific type of twill weave is typically designated as a fraction in which the numerator indicates the number of harnesses that are raised and the denominator indicates the number of harnesses that are lowered. As an example, a “3/1” twill pattern will pass a weft yarn over three warp yarns and then under one warp yarn in a repeating pattern. This twill fabric will have more surface area of weft yarns exposed on one side and more surface area of warp yarns exposed on the other side.

In exemplary embodiments using a twill weave, the warp yarns may have a denier of less than 100 denier. In exemplary embodiments of a twill weave the warp yarns may have a denier in a range of 20-100 denier. In exemplary embodiments of a twill weave the warp yarns may have a denier in a range of 30-70 denier. In exemplary embodiments of a twill weave the weft yarns may have a denier of at least 100 denier. In exemplary embodiments of a twill weave the weft yarns may have a denier in a range of 100-1000 denier. In exemplary embodiments of a twill weave the weft yarns may have a denier in a range of 150-600 denier.

In exemplary embodiments, the fabric is calendered. Calendering is a process where the fabric is passed through a pressure nip of two rollers under high pressure and often heat. Calendering the fabric performs several functions. Calendering reduces the thickness of the fabric so that the individual tape roll diameters are smaller and more manageable to hold by the assembly line workers. Also, calendaring smooths and may partially seal the surface of the fabric to reduce adhesive penetration into the fabric. A liquid pressure sensitive adhesive (in exemplary embodiments, a solvent solution of an acrylic polymer) may be coated directly onto the fabric and dried or cured, such as in a convection oven. In exemplary embodiments, penetration of the adhesive into the fabric may be only as much as is needed for the adhesive to anchor itself. Excess adhesive penetration requires more adhesive to be applied than would normally be required to perform its function, thereby adding unnecessary cost.

In exemplary embodiments, at least one layer of at least one sealant material is applied to the fabric. In exemplary embodiments, the sealant may be a water-based polyurethane emulsion. Other possible sealants include, but are not limited to, emulsions or solutions of acrylic polymers or copolymers, polyurethane polymers, silicone polymers, synthetic elastomer polymers or copolymers, mixtures of at least two of the foregoing, and the like. In exemplary embodiments, the sealant may be coated onto the fabric via a gravure coating process prior to the liquid adhesive application. The sealant coating or layers of coating may be applied by any suitable coating process, such as, but not limited to, gravure, offset gravure, flexography, wire-wound (Meyer) rod, reverse roll, multiple roll offset, slot die, spray, knife-over-roll, dip (immersion), curtain, comma, or other suitable coating processes known to those skilled in the art. The coating process may be done at room temperature or at an elevated temperature selected to provide viscosity modification of the sealant suitable for the coating process.

In one exemplary embodiment, the sealant may be a polyurethane dispersion such as, but not limited to, Permax™ 202, available from The Lubrizol Corporation.

The sealant may be applied as a single layer or may be applied as multiple layers. The sealant may be applied as a single material or a mixture of sealant materials. The sealant may be applied in several with each layer being a different sealant material. The sealant may be applied to one face or to both faces. The sealant may be applied as a continuous coating or a non-continuous coating, such as, but not limited to, as zones or a pattern. The sealant resides between the adhesive and the fabric to seal the fabric from adhesive penetration through to the other face of the fabric. The sealant by itself also improves the hand tearability of the fabric.

In exemplary embodiments, an adhesive is applied to one face of the fabric. In exemplary embodiments, the adhesive may be applied to both faces of the fabric. In exemplary embodiments, the adhesive is applied to the sealant(s). In exemplary embodiments, the adhesive may be applied as a continuous coating or a non-continuous coating, such as, but not limited to, coating just a portion of the fabric, or in zones, spots or a pattern. In exemplary embodiments, the adhesive is applied to the warp face. In exemplary embodiments, the adhesive is applied to the weft face. In one exemplary embodiment, the adhesive may be applied to a portion of the weft face, such as along one edge to produce an abrasion sleeve (as described further hereinbelow). In such an embodiment, useful for longitudinal wrapping of wire harnesses, cable sets and other materials, the adhesive does not need to contact the wires directly. This may maintain maximum flexibility of the material wrapped. The adhesive may be applied by any suitable coating process, such as gravure, offset gravure, flexography, wire-wound (Meyer) rod, reverse roll, multiple roll offset, slot die, spray, knife-over-roll, curtain, comma, or other suitable coating processes known to those skilled in the art. The coating process may done be at room temperature or at an elevated temperature selected to provide viscosity modification of the adhesive suitable for the coating process.

In exemplary embodiments, the adhesive may be a solution-based, polyacrylic pressure sensitive adhesive (“PSA”). In exemplary embodiments, other similar adhesives may be used with glass transition temperatures (“T_{g}”) in the range −50° C. to 0° C. and a modulus (“G′”) at 25° C. in a range between 10-200 KPa (measured at 1.0 radians per second). Pressure sensitive adhesives of this type are commercially available, for example (but by way of limitation), Henkel Duro-TAK™, Ashland Aroset™, and Avery S8xxx series. Depending on the temperature, environmental or performance requirements of the tape, other suitable pressure sensitive adhesives may be selected. These include, but are not limited to, polyacrylic pressure sensitive adhesive emulsions as well as those PSA's based on acrylic polymers in an interpenetrating network of polyurethane, silicone, or other polymer. Additional types of PSA's which may be suitable include those of silicone, polyurethane, or other polymers with inherent visco-elastic behavior and a modulus meeting the Dahlquist criterion (G′<0.3 MPa). Pressure sensitive adhesives compounded from synthetic or natural elastomeric polymers, tackifying resins, plasticizers and other components meeting the Dahlquist criterion may also be suitable.

In one exemplary embodiment, the adhesive may be an acrylic adhesive, such as, but not limited to, S8765 adhesive, available from Avery Dennison Performance Polymers.

The adhesive tape may be manufactured as a long strip which may be slit into tape using score, shear, razor or thermal knives. The score knives can be straight or pinked. Pinking will provide a starting point to propagate the hand tear and will also reduce the occurrence of long warp threads being pulled from the tape edge at the far end of the tear. In exemplary embodiments, either one or both side edges of the tape may be pinked. The tape can be wound into a roll, thus forming an adhesive tape manufactured in roll form. Alternatively, after the adhesive is applied to the fabric and dried or cured, the tape can be cut into sheets, segments, strips or the like.

One feature of the adhesive tape as manufactured in a roll form as presently disclosed is that the sealant can be applied to the “outer” or front face of the fabric, and the adhesive applied to the outer face such that the adhesive does not penetrate the fabric through to the “inner” or back face surface. In such an exemplary embodiment, when the adhesive tape so formed is wound, the inner face of one wind contacts the outer face of the adjacent wind and, because the adhesive in such an embodiment does not extend through to the inner face surface, the tape is unwindable by hand without undue effort. Without the sealant the adhesive, when applied to the fabric, might penetrate through to the other side such that when wound, the adhesive on one face would be in contact with and stick to the adhesive on the other face, resulting in a tape roll that would be more difficult to unroll. In exemplary embodiments, an adhesive tape roll formed as described herein that does not require a release liner would be less expensive to manufacture, and, it would produce less waste when used.

In exemplary embodiments, no release liner is included. In other exemplary embodiments, for certain tape construction formulations a release liner may be included to facilitate unwinding of a tape roll or as a backing for non-rolled manufactured tape configurations, such as, but not limited to, patches, segments, sheets, and the like.

In exemplary embodiments, a tape produced as described herein has abrasion resistance of greater than 1000 cycles, as tested according to the Method ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11 (all published standards discussed herein are incorporated herein by reference in their entirety). In exemplary embodiments, a tape produced as described herein has abrasion resistance in a range of 1000-5000 cycles, as tested according to the Method ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11.

The BMW Group Standard is shown below:

BMW Group Standard 95008-3

| | Anforderung |
|---|---|
| Abriebklasse | Requirement |
| Wear Category | Hübe/Strokes |
| A | <100 |
| Kein Abriebschutz | |
| No wear protection | |
| B | 100 bis/to 499 |
| Geringer Abriebschutz | |
| Little wear protection | |
| C | 500 bis/to 999 |
| Mittlerer Abriebschutz | |
| Medium wear protection | |
| D | 1000 bis/to 4999 |
| Hoher Abriebschutz | |
| High wear protection | |
| E | ≧5000 |
| Sehrhoher Abriebschutz | |
| Very high wear protection | |

The Ford Engineering Specification is shown below:

Ford Engineering Specification ES-AC3T-1A303-AA

| | Requirement |
|---|---|
| Wear Category | (strokes) |

| | | |
|---|---|---|
| 0 | No wear protection | <100 |
| 1 | Little wear protection | 100-499 |
| 2 | Medium wear protection | 500-999 |
| 3 | High wear protection | 1000-4999 |
| 4 | Very high wear protection | >4999 |
| N | Not tested | N/A |

In exemplary embodiments, a tape produced as described herein has abrasion resistance great enough to permit a rating of “High Wear Protection.” In exemplary embodiments, an adhesive tape produced as described herein has tearability of about 1000 g or less as measured by the Elmendorf tear method, ASTM D-1424. In exemplary embodiments, an adhesive tape produced as described herein has both the abrasion resistance (wear protection) and the tearability qualities as described hereinabove.

In the wire harness industry, the predominate color of the tape has been black. The plain weave fabric of certain commercially available wire harness tape requires both the warp and weft yarns to be dyed black. If only one or the other warns was dyed black, the resulting plain weave fabric would be a combination of white and black yarns and exhibit a gray color. A non-symmetrical weave fabric with a small, white yarn used for the warp (such as 40 denier) and a large, black yarn used for the weft (such as 300 denier) would appear almost black when viewed on the weft face (and somewhat gray on the warp face).

In exemplary embodiments, the tape has adhesive applied to the warp face and has the weft face exposed to view. This provides an opportunity to change the color of the fabric on a non-symmetrical weave more easily than on a plain weave. For the plain weave, both the warp and weft yarns must be dyed the same color. For each color of plain weave, a separate warp beam must be created. Then one colored warp beam would need to be removed from the loom and another color beam would need to be mounted. A warp beam is a roller, located at the back of a loom, on which the warp ends are wound in preparation for weaving. For a non-symmetrical weave, only the weft yarn color needs to be changed; the white yarn warp beam would remain on the loom and only the weft yarn would require changing. In exemplary embodiments, this weft yarn change may take, for example, 5-10 minutes, compared to the 2-3 days it may take to change a warp beam. Also, only one warp beam would need to be produced no matter how many colors were required. This ability can offer a significant market benefit as the traditional black wiring harness is becoming orange where high voltage DC wiring is routed in hybrid and battery powered vehicles.

In a conventional weaving process, the weft yarns are inserted perpendicularly to the warp yarns. If a distinct colored fabric is desired in a plain (i.e., symmetrical) woven fabric, the warp yarns and the fill yarns are typically dyed the same desired color. The loom upon which the fabric is woven consists of a warp beam of continuous yarns. In exemplary embodiments, a method is provided for producing an adhesive tape utilizing a woven fabric. A loom may be configured with a warp beam having a first color yarn and a weft beam having a second color yarn. The loom is used to weave the fabric and the weft beam may be changed where a third color weft yarn is used; however, the warp beam is not changed from the first color yarn. The fabric thus formed is treated with a sealant as described herein in various exemplary embodiments. In exemplary embodiments, the sealant may contain a color pigment. An adhesive is applied to the sealant-treated fabric to form the adhesive tape. The tape thus formed can be rolled onto a roll or formed into other forms.

A non-symmetrical woven fabric (such as, but not limited to, a 5-harness satin) has a unique advantage when the yarn size of the warp beam is significantly smaller than that of the weft, namely, the warp beam can be un-dyed or natural while only the weft yarns are dyed with the resulting fabric (when the ‘weft’ side is viewed) exhibits essentially the desired color. This permits economies of material (unnecessary to dye the warp beam) and efficiencies in weaving various colors as only the differently dyed weft yarns need to be changed.

One feature of the adhesive tape according to certain exemplary embodiments described herein is that, with the non-symmetrical weave construction of the fabric, the abrasion resistance is not as dependent on the warp yarn size or denier to achieve the abrasion resistance as the exposure of the warp yarns to the abrading wire is minimal in this non-symmetrical weave. This allows the warp yarn denier to be selected such that the fabric is hand-tearable without compromising the abrasion resistance, which is achieved by the weft yarn weight or denier selection. Consequently, the weft yarns can be robustly sized to provide abrasion resistance without sacrificing the hand-tear properties provided by the smaller warp yarns. The non-symmetrical weave also allows for use of a denser weft yarn count, thus further increasing the abrasion resistance of the presently disclosed non-symmetrical weave fabric over a plain weave.

Automobile manufacturers require protection of electrical wiring harnesses from the possibility of external abrasive wear penetrating the insulation with a resulting electrical short to ground. Specially designed wiring harness tapes have been used for this purpose on selected areas of the harness. These tapes are typically made with a woven polyester fabric backing that is designed to withstand a minimum of 1000 cycles of wire scrape abrasion when tested to the ISO-6722 test method, as modified and described hereinabove. Current tapes meeting this requirement utilize a plain weave polyester fabric to achieve high abrasion resistance and also high temperature (150° C.) resistance. Conventional tapes commonly referred to as ‘high abrasion resistant’ or ‘high wear protection’ tapes cannot ordinarily be torn by hand; they must be cut. Sharp tools in proximity to electrical wires creates the possibility of cutting the wire or nicking the insulation thereby creates a potential failure mode in the electrical harness, which might go undetected prior to installation of the harness on the assembly line. A faulty wiring harness can result in substantial warranty claims for the automobile manufacturer. One aspect of exemplary embodiments of the adhesive tape disclosed herein is the ability of the tape to be hand torn, which obviates the need for a knife or scissors when the length of tape to be applied is being separated from the roll or other form.

Other abrasion resistant tapes achieve the requisite abrasion resistance by (1) utilizing a densely woven, plain weave polyester fabric backing with warp yarns 150 denier or greater in weight (such tapes are generally not hand-tearable), (2) using a polyamide (such as, but not limited to, Nylon) plain weave fabric that is not hand-tearable, or 3) using a multi-layer laminate that is not hand-tearable. Others provide hand-tearable tapes with woven polyester fabric, but these tapes generally do not achieve the ‘High Wear Protection’ rating. Exemplary embodiments of the present adhesive tape provide the requisite abrasion resistance while being hand-tearable.

Currently available adhesive tapes that achieve high abrasion resistance use a plain weave polyester fabric tape backing utilizing a dense weave and relatively thick, heavy yarns in the warp direction, typically 150 denier or higher. In order to hand-tear the tape, a tear must propagate parallel to the weft (fill) yarns, perpendicular to the warp yarns, and break each warp yarn in sequence. Polyester warp yarns thicker or heavier than about 100 denier cannot generally be torn by hand. Plain woven polyester fabrics with warp yarns less than 150 denier (regardless of yarn density) will not meet the 1000 cycle abrasion test minimum. Exemplary embodiments of the present adhesive tape made from non-symmetrical woven fabric provide the requisite abrasion resistance and are hand-tearable.

In addition, there are several levels of abrasion resistance ratings for harness tape. A fabric for each abrasion rating can be created according to various exemplary embodiments by varying the weft yarn denier count without changing the warp beam. This not only preserves the hand tear, but allows the non-symmetrical weave fabric to provide a lower cost for lower performance.

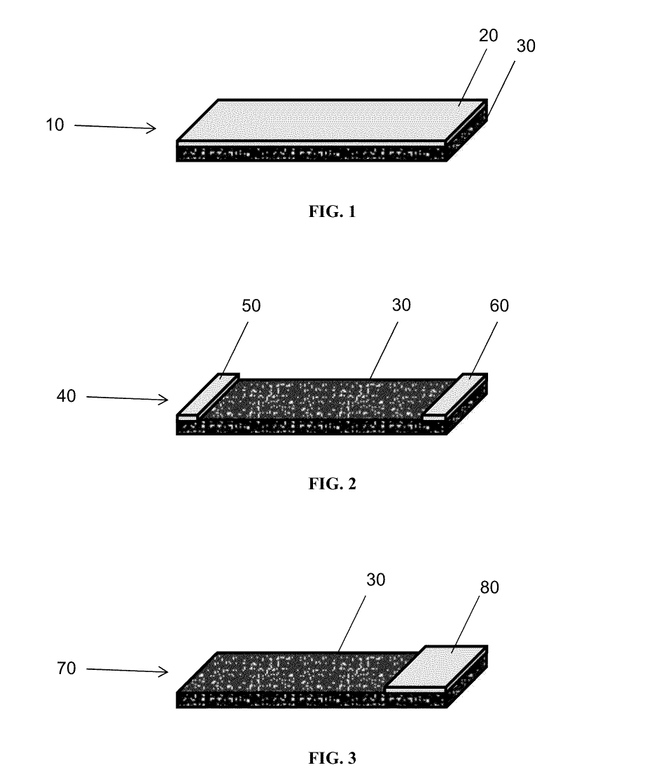

Self-adhesive abrasion tapes are applied to wiring harness bundles or convolute in a spiral wrap with typically a 50% overlap. In exemplary embodiments, an adhesive tape is provided whereby a user can longitudinally wrap a strip of such tape onto the section of wiring harness requiring abrasion protection. This type of protection is commonly called a “sleeve” and is often able to provide equivalent abrasion protection with less material (i.e., less overall thickness as applied to the harness). Sleeves often provide increased flexibility in the assembled wiring harness, which aides in harness installation on the assembly line. Sleeves typically consist of a longitudinal coating of a band of adhesive (zone-coated) along one or both sides of the abrasion tape. Exemplary embodiments of sleeve constructions according to the present disclosure, including the fabric and adhesive (optional sealant is not shown), are shown in FIGS. 1-3: FIG. 1 illustrates a continuous spiral harness wrap 10 (the upper layer 20 is the adhesive and the bottom layer 30 is the woven fabric). FIG. 2 illustrates a first construction of a protective sleeve 40 for a longitudinal harness wrap in which at least one band of adhesive 50, 60 is located at each end of the fabric 30. FIG. 3 illustrates a second construction of a protective sleeve 70 for a longitudinal harness wrap in which a band of adhesive 80 is located at just one end of the fabric 30.

In exemplary embodiments, a method for forming an adhesive tape is provided comprising providing fabric made of a non-symmetrical weave material, such as, but not limited to, a satin weave or a twill weave, and applying at least one layer of at least one sealant material to at least one face of the fabric. In exemplary embodiments, the sealant is dried. At least one layer of at least one adhesive is applied to the fabric, such as by coating. In exemplary embodiments, the adhesive is applied to the fabric face to which the sealant has been applied. The adhesive is then dried.

### EXAMPLES

The following examples are set forth for purposes of illustration only. Parts and percentages appearing in such examples are by weight unless otherwise stipulated.

### Example 1

### Satin Weave

A 5-harness satin weave fabric made of PET polyester warp yarn and weft yarn was used having 112 ends/inch (warp)×100 picks/inch (weft), 40 denier warp×300 denier weft, in which the warp yarn was not dyed and the weft yarn was solution dyed black. The fabric was calendered.

A sealant of Permax™ 202, (available from Lubrizol Corp.), a water-based polyurethane emulsion, was applied via gravure coating to the warp face of the fabric at an average rate of 15 gram per meter² (the range was range 5-30 gram per meter²).

An acrylic adhesive (available from Avery Dennison Performance Polymers as S8765), was coated via slot die at an average rate of 55 gram per meter² (the range was range 30-90 gram per meter²) and dried in a multi-zone convection oven.

### Example 2

### Tape Roll Formation

The adhesive fabric tape thus formed was slit into individual tape rolls of 1-inch or ¾-inch wide by 100 feet long. The slitting is performed by score knives, which can be straight or pinked. The slitted tape was wound onto a roll.

### Example 3

### Testing

Abrasion resistance of the tape of Example 2 was tested according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11. The results of the abrasion resistance testing are shown in Table 2. The average scrape abrasion cycles over 35 samples was 3,483.

TABLE 2

| Sample | Scrape Abrasion Cycles |
|---|---|
| 1 | 3591 |
| 2 | 3809 |
| 3 | 3904 |
| 4 | 3125 |
| 5 | 3174 |
| 6 | 3406 |
| 7 | 3809 |
| 8 | 3660 |
| 9 | 3635 |
| 10 | 3770 |
| 11 | 3419 |
| 12 | 3537 |
| 13 | 3747 |
| 14 | 3489 |
| 15 | 3380 |
| 16 | 3179 |
| 17 | 3734 |
| 18 | 3649 |
| 19 | 3511 |
| 20 | 3100 |
| 21 | 3865 |
| 22 | 3066 |
| 23 | 3778 |
| 24 | 3127 |
| 25 | 3418 |
| 26 | 3519 |
| 27 | 3520 |
| 28 | 3055 |
| 29 | 3387 |
| 30 | 3808 |
| 31 | 3492 |
| 32 | 3199 |
| 33 | 3352 |
| 34 | 3308 |
| 35 | 3382 |
| Average | 3483 |

Tear resistance of the tape of Example 2 was tested according to the Elmendorf testing method. The results of the tear resistance testing are shown in Table 3.

TABLE 3

| Sample # | Elmendorf Tear, grams |
|---|---|
| 1 | 320 |
| 2 | 294 |
| 3 | 333 |
| 4 | 332 |
| 5 | 307 |
| 6 | 333 |
| 7 | 371 |
| 8 | 333 |
| 9 | 320 |
| 10 | 294 |
| 11 | 358 |
| 12 | 330 |
| Average | 327 |

Tear force less than 1000 g is generally hand tearable, although lower values are preferable.

### Example 4

### Comparison of Fabric with Sealant, and Bare Fabric

The sealant was applied to the fabric according to the method described in Example 1. The results of the testing are shown in Table 4.

TABLE 4

Elmendorf Tear, grams

| Sample # | Bare Fabric | Sealant + Fabric |
|---|---|---|
| 1 | 2995 | 716 |
| 2 | 2668 | 1024 |
| 3 | 2414 | 781 |
| 4 | 2358 | 858 |
| 5 | 2344 | 678 |
| 6 | 2414 | 742 |
| 7 | 2452 | 755 |
| 8 | 2792 | 986 |
| 9 | 2662 | 742 |
| 10 | 2598 | 781 |
| 11 | 2547 | 704 |
| 12 | 2126 | 768 |
| Average | 2531 | 795 |

### Example 5

A comparison test was performed comparing plain weave with twill weave and satin weave contrasts 70 denier warp (having hand tear judged as ‘fair’) to 40 denier warp (having hand tear judged as ‘good’) and the effect of weave type on scrape abrasion resistance. Testing was according to ISO-6722, modified according to BMW LV-312. The fabric and yarn specifications were from the fabric vendor. Ratios are calculated values. The results of the test are shown in Table 5.

TABLE 5

| | | | | | | | | | | Fill to | | |
|---|---|---|---|---|---|---|---|---|---|---|---|---|
| Warp | | | | | Fill | | | | | Warp | | |
| | | Ends/ | Ends/ | Warp | | | Picks/ | Picks/ | Fill | Density | | Abrasion |
| Denier | dtex | inch | cm | Density | Denier | dtex | inch | cm | Density | Ratio | Weave | Resistance |
| 70 | 77.8 | 60 | 24 | 1837 | 150 | 166.7 | 86 | 34 | 5,643 | 3.07 | Plain | 121 |
| 70 | 77.8 | 90 | 35 | 2756 | 150 | 166.7 | 130 | 51 | 8,530 | 3.10 | Twill | 398 |
| 70 | 77.8 | 90 | 35 | 2756 | 300 | 333.3 | 90 | 35 | 11,811 | 4.29 | Twill | 1737 |
| 70 | 77.8 | 90 | 35 | 2756 | 450 | 500.0 | 70 | 28 | 13,780 | 5.00 | Twill | 3260 |
| 40 | 44.4 | 112 | 44 | 1960 | 150 | 166.7 | 110 | 43 | 7,218 | 3.68 | Twill | 401 |
| 40 | 44.4 | 112 | 44 | 1960 | 300 | 333.3 | 80 | 31 | 10,499 | 5.36 | Twill | 533 |
| 40 | 44.4 | 112 | 44 | 1960 | 300 | 333.3 | 100 | 39 | 13,123 | 6.70 | 5H Satin | 3483 |
| 40 | 44.4 | 112 | 44 | 1960 | 300 | 333.3 | 90 | 35 | 11,811 | 6.03 | 5H Satin | 2521 |
| 40 | 44.4 | 112 | 44 | 1960 | 300 | 333.3 | 120 | 47 | 15,748 | 8.04 | 10H | 4041 |
| | | | | | | | | | | | Satin | |
| 40 | 44.4 | 112 | 44 | 1960 | 450 | 500.0 | 80 | 31 | 15,748 | 8.04 | 5H Satin | 4009 |
| 40 | 44.4 | 112 | 44 | 1960 | 450 | 500.0 | 100 | 39 | 19,685 | 10.04 | 10H | 6444 |
| | | | | | | | | | | | Satin | |
| 40 | 44.4 | 112 | 44 | 1960 | 450 | 500.0 | 105 | 41 | 20,669 | 10.55 | 10H | 5378 |
| | | | | | | | | | | | Satin | |

The abrasion resistance results for the 40 denier warp were not as high as for the 70 denier warp. These results led us to the satin weave, which permitted a denser weft yarn pick count and raised the abrasion resistance with the 40 denier warp yarn.

In addition to the Scrape Abrasion Test, Sandpaper Abrasion Test (0.34 kg, Delphi EST-329A) also quantifies the abrasion resistance of harness wrapping tapes and sleeves. Table 6 shows the results of this test (in millimeters), with values exceeding 1000 mm and an average of 1583 mm. The test temperature was done at 23° C. with a mandrel size of 12 mm.

TABLE 6

| | | | | | | | | | Ad- |
|---|---|---|---|---|---|---|---|---|---|
| | | | | | | | | | justed |
| 1 | 2 | 3 | 4 | 5 | 6 | 7 | 8 | Avg. | Avg. |
| 1672 | 1899 | 1517 | 1601 | 1591 | 1593 | 1598 | 1596 | 1633 | 1583 |

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts. It should further be noted that any patents, applications, publications and standard test methods referred to herein are incorporated by reference in their entirety

1. A hand-tearable adhesive tape, comprising:
(a) a fabric having a first face and a second face and comprising a material woven in a non-symmetrical pattern of warp yarns and weft yarns; and,
(b) an adhesive associated with the fabric.

2. The tape of claim 1, further comprising at least one sealant applied to at least one face of the fabric.

3. The tape of claim 1, wherein the first face has a greater amount of warp yarns than weft yarns showing and the second face has a greater number of weft yarns than warp yarns showing.

4. The tape of claim 1, wherein the non-symmetrical pattern is a satin weave.

5. The tape of claim 1, wherein the non-symmetrical pattern is a weave comprising at least four weft yarns floating over a warp yarn.

6. The tape of claim 1, wherein the tape is configured to be a roll.

7. The tape of claim 1, wherein the warp yarns have a denier less than 100.

8. The tape of claim 1, wherein the warp yarns have a denier in a range of between 20 and 150.

9. The tape of claim 1, wherein the warp yarns have a denier in a range of between 20 and 100.

10. The tape of claim 1, wherein the warp yarns have a denier in a range of between 30 and 70.

11. The tape of claim 1, wherein the weft yarns have a denier of at least 100.

12. The tape of claim 1, wherein the weft yarns have a denier in a range of between 100 and 1000.

13. The tape of claim 1, wherein the weft yarns have a denier in a range of between 300 and 600.

14. The tape of claim 1, wherein the non-symmetrical pattern is a twill weave.

15. The tape of claim 14, wherein the non-symmetrical pattern comprises diagonal parallel ribs in which the pattern of weft in one row is offset from the weft pattern in the adjacent rows.

16. The tape of claim 14, wherein the twill weave is a broken twill weave.

17. The tape of claim 14, wherein the twill weave comprises a pattern having 1 weft yarn over 3 warp yarns and under 1 warp yarn.

18. The tape of claim 14, wherein the warp yarns have a denier less than 100.

19. The tape of claim 14, wherein the warp yarns have a denier in a range of range of between 20 and 150.

20. The tape of claim 14, wherein the warp yarns have a denier in a range of between 20 and 100.

21. The tape of claim 14, wherein the warp yarns have a denier in a range of between 30 and 70.

22. The tape of claim 14, wherein the weft yarns have a denier of at least 100.

23. The tape of claim 14, wherein the weft yarns have a denier in a range of between 100 and 1000.

24. The tape of claim 14, wherein the weft yarns have a denier in a range of between 300 and 600.

25. The tape of claim 1, wherein the fabric is calendared.

26. The tape of claim 1, wherein the adhesive penetrates either the first face or second face of the fabric only partially and not entirely through from the first face to the second face.

27. The tape of claim 2, wherein the sealant material comprises at least one material selected from the group consisting of acrylic polymers, copolymers of acrylic polymers, polyurethane polymers, silicone polymers, synthetic elastomer polymers, synthetic elastomer copolymers and mixtures thereof.

28. The tape of claim 2, wherein the sealant material comprises a mixture of different sealant materials.

29. The tape of claim 2, wherein the sealant material is a water-based polyurethane emulsion.

30. The tape of claim 2, wherein the sealant material is applied to both first and second faces.

31. The tape of claim 2, wherein the sealant material is present in the fabric such that the sealant material penetrates either the first or second face and only partially through the fabric without penetrating entirely through the fabric.

32. The tape of claim 2, wherein the adhesive is associated with the at least one sealant material and the fabric.

33. The tape of claim 1, wherein the adhesive comprises a pressure sensitive adhesive made of at least one material selected from the group consisting of polyacrylic emulsion, silicone, and polyurethane.

34. The tape of claim 1, wherein at least one of the warp yarns is made of at least one material selected from the group consisting of polyester, polyaramide, polyamide, polybenzimidazole, polyacrylonitrile (PAN)-based carbon, polyetheretherketone, poly(acrylonitrile), poly(acrylate), an aromatic liquid crystal, polyurethane, a plant fiber-based material, and an animal fiber-based material.

35. The tape of claim 1, wherein the tape has abrasion resistance of at least 1000 cycles, as measured according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11.

36. The tape of claim 1, wherein the tape has abrasion resistance in a range of between 1000 and 5000 cycles, as measured according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11.

37. The tape of claim 1, wherein the tape has hand tearability of 1000 g or less as measured by the Elmendorf tear method, ASTM D-1424.

38. The tape of claim 3, wherein the adhesive is applied to the first face.

39. The tape of claim 1, further comprising a colored dye applied to at least one face of the tape.

40. The tape of claim 1, wherein the tape has a tear resistance of 1000 g or less as measured by the Elmendorf tear method, ASTM D-1424, and has abrasion resistance of at least 1000 cycles, as measured according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11.

41. The tape of claim 1, wherein the adhesive has a Tg of −50° C. to 0° C.

42. The tape of claim 1, wherein the adhesive has a modulus (“G′”) at 25° C. in a range of between 10-200 KPa (measured at 1.0 radians per second).

43. The tape of claim 1, wherein the color of the tape can be changed during manufacture without requiring a change of a warp beam to a different color warp yarn.

44. A hand-tearable adhesive tape, comprising:
(a) a fabric comprising a polyester material woven in a non-symmetrical pattern of comprising at least four weft yarns floating over a warp yarn and having a first face and a second face, the warp yarn having a denier of 40, the weft yarn having a denier of 300 and the fabric having a density ratio greater than 6.0;
(b) at least one acrylic adhesive; and,
(c) at least one sealant comprising a water-based polyurethane emulsion,
wherein the tape has abrasion resistance of at least 3000 cycles, as measured according to the ISO-6722 test method, Section 9.3 “Scrape Abrasion” as modified in BMW Group Standard 95008-3 (formerly LV-312), Section 7.5.3 and in Ford Engineering Specification ES-AC3T-1A303-AA, Section 7.11, and
wherein the tape has tear resistance of less than 370 g as measured by the Elmendorf tear method, ASTM D-1424.

45. The tape of claim 44, wherein the tape is manufactured in a roll.

46. The tape of claim 45, wherein the tape roll has the first face in direct contact with the second face in adjacent windings of the rolled tape.

47. The tape of claim 45, wherein the roll is adapted to be unwindable by hand.

48. The tape of claim 45, wherein the tape has a first side edge and a second side edge, at least one of which is pinked.

49. A hand-tearable adhesive tape, comprising:
(a) a fabric having a first face and a second face and comprising a material woven in a symmetrical twill pattern of warp yarns and weft yarns;
(b) at least one sealant; and,
(c) at least one adhesive associated with the fabric.

50. A method for forming an abrasion resistant hand-tearable adhesive tape, comprising;
(a) providing fabric having a first face and a second face and made of a non-symmetrical weave material;
(b) applying at least one layer of at least one sealant material to at least one face of the fabric; and,
(c) applying at least one layer of at least one adhesive to the fabric.
